(19) United States
(12) Patent Application Publication
(10) Pub. No.: US 2009/0002410 A1
(43) Pub. Date: Jan. 1, 2009

(54) Inkjet Printer and Printing Method

(75) Inventors: Kazue Shirota, Chiba (JP); Fumio Otsuka, Chiba (JP)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: SEIKO PRECISION INC.

(21) Appl. No.: 10/585,432

(22) PCT Filed: Jan. 11, 2005
(86) PCT No.: PCT/JP2005/000201

§ 371 Date: Jul. 7, 2006

(30) Foreign Application Priority Data
Jan. 9, 2004 (JP) 2004-004449

(51) Int. Cl. B41J 25/308

(52) U.S. Cl. 347/8

(57) ABSTRACT

Data is printed predetermined number of times on a print area having a width W₂ smaller than the maximum print width W₁ of a print head (26) by using predetermined ink nozzles (26d) while moving a print medium F relative to the print head (26) in a state that the position of the print head (26) in a direction perpendicular to a feeding direction X of the print medium F is fixed. After that, the print head (26) is moved in the direction perpendicular to the feeding direction X of the print medium F each time printing has been performed the predetermined number of times while the print medium F is moved at a predetermined pitch at a time, and printing is again performed on the print area by using ink nozzles (26d) which are different at least partly from the ink nozzles (26d) which were used before the move, in the state that the print head (26) is fixed.

### TECHNICAL FIELD

The present invention relates to an inkjet printer, particularly a line inkjet printer, and its printing method.

### BACKGROUND ART

Inkjet printers are roughly categorized into a serial type which drives its print head in a row direction during printing, and a line type which performs printing without moving its print head.

Serial inkjet printers are generally used for consumer use. Line inkjet printers are used for industrial use for printing date of manufacture (expiration date), barcode, block code, etc. on predetermined print target areas of print media such as, for example, packaging films, cardboard boxes, etc. Serial inkjet printers have multiple ink nozzles that are arranged in the direction of feeding a print medium, and perform printing while moving the print head in a direction (row direction) perpendicular to the direction of feeding the print medium.

Serial inkjet printers move the print media ahead by 1 row when finished with printing of 1 row. Line inkjet printers have multiple ink nozzles that are arranged in a direction perpendicular to the direction of moving a print medium, and perform printing while conveying the print medium.

The width of the print target area on the print medium is generally narrower than the printable width (maximum print width) of the print head of the line type. Therefore, the ink nozzles that spread as wide as the printable width are not used altogether simultaneously in ordinary use, and those nozzles that are positioned outside the print target area are seldom used. Especially, if the same print job is repeated, such a situation might occur that only some part of the ink nozzles are used repeatedly, and certain ink nozzles are hardly used. Ink nozzles that are not used are more likely to cause ink ejection troubles. Therefore, the ink nozzles need to be cleaned frequently. Further, ink nozzles that are used more often and ink nozzles that are not used so much will have a gap in their life, resulting in shortening the life of the print head as a whole.

Patent Literature 1 discloses an inkjet printer capable of high-density printing with the use of ink nozzles arranged at a low density. This inkjet printer is structured so as to be able to move its print head in a direction in which the ink nozzles are arranged (row direction) by a minute pitch that is smaller than the pitch at which the ink nozzles are arranged. By performing printing while moving the print head in the row direction by that minute pitch, this inkjet printer enables high-density printing in appearance.

The technique disclosed in the Patent Literature 1 can perform printing at a high density by using ink nozzles of low-density arrangement. However, this technique cannot solve the problem of a gap in life arising between ink nozzles used frequently and ink nozzles hardly used, and the problem of the life of the print head as a whole being reduced due to the gap in life arising.

Patent Literature 1: Unexamined Japanese Patent Application KOKAI Publication No H6-71947

### DISCLOSURE OF INVENTION

### Problem to be Solved by the Invention

An object of the present invention is to reduce the problem of life gap between ink nozzles used and ink nozzles not used and to improve the life of the print head as a whole.

Another object of the present invention is to prevent ink nozzles not used from being clogged.

### Means for Solving the Problem

To achieve the above objects, an inkjet printer according to a first aspect of the present invention comprises:

a print head having a plurality of ink nozzles arranged in a direction perpendicular to a direction of feeding a print medium;

a print head control circuit which drives the print head in the direction perpendicular to the direction of feeding the print medium;

a position detection circuit which detects a position (relative position) of the print medium with respect to the print head; and

a print control circuit which performs printing on a print area whose width is smaller than a maximum print width of the print head by using predetermined ink nozzles of the print head while moving the print medium relative to the print head, moves the print head in the direction perpendicular to the direction of feeding the print medium via the print head control circuit each time it has performed printing a predetermined number of times while moving the print medium based on the position detected by the position detection circuit, and again performs printing on the print area by using ink nozzles which are different at least partly from the predetermined ink nozzles.

In the inkjet printer having the above-described structure, the print control circuit may perform printing in a state that a position of the print head in the direction perpendicular to the direction of feeding the print medium is fixed, may move the print head via the print head control circuit in the direction perpendicular to the direction of feeding the print medium each time it has performed printing the predetermined number of times, and may again perform printing in a state that the print head is fixed.

In the inkjet printer having the above-described structure, the print control circuit may perform a control of moving the print head via the print head control circuit from an initial position at which printing on the print area is performed for a first time to one end of movement along the direction perpendicular to the direction of feeding the print medium while repeatedly performing printing on the print area and may perform a control of moving the print head via the print head control circuit from the one end of movement to the initial position along the direction perpendicular to the direction of feeding the print medium while repeatedly performing the same printing on the print area.

In the inkjet printer having the above-described structure, the print head control circuit may comprise a buffer memory on which a dot pattern, which is objective data to be printed, is expanded, and the print head control circuit may shift a position at which the print-object dot pattern data is expanded in accordance with movements of the print head.

In the inkjet printer having the above-described structure, the position detection circuit may comprise: a mark which is given on the print medium at predetermined intervals in the feeding direction; a sensor which detects the mark; and an encoder which detects an amount of the print medium being fed. It is preferred that the encoder should comprise a slave roller which rotates while keeping in contact with a surface of the print medium, and should detect an angle of rotation of the slave roller.

To achieve the above objects, a printing method using an inkjet printer according to a second aspect of the present invention is a printing method for performing printing by using a print head having a plurality of ink nozzles, and comprises:

a printing step of performing printing on a print target area whose width is smaller than a maximum print width of a print head by using a predetermined ink nozzle head while moving a print medium relative to the print head; and

a moving step of detecting that printing has been performed a predetermined number of times, and moving the print head in a direction perpendicular to a direction of feeding the print medium,

wherein after the print head is moved, printing is performed at the printing step on the print target area on the print medium, by using ink nozzles which are different at least partly from ink nozzles which were used for printing before the move.

In the printing method having the above-described configuration, for example, the printing step comprises a step of performing printing on a specific print position whose width is smaller than the maximum print width of the print head by using predetermined ink nozzles while further moving the print medium relative to a head carrier by a predetermined pitch at a time, in a state that a position of the print head in the direction perpendicular to the direction of feeding the print medium is fixed, and the moving step comprises a step of moving the head carrier via the head carrier control circuit in the direction perpendicular to the direction of feeding the print medium.

In the printing method having the above-described configuration, for example, at the moving step, the print head is moved each time it is detected that printing has been performed the predetermined number of times, and each time the print head is moved at the moving step, printing is performed at the printing step by using ink nozzles which are different at least partly from ink nozzles which were used for printing before the move.

In the printing method having the above-described configuration, for example, detection of a relative position of the print medium comprises a step of detecting a mark given on the print medium at predetermined intervals in the feeding direction, and a step of detecting an amount of the print medium being fed.

To achieve the above objects, an inkjet printer according to a third aspect of the present invention comprises:

a print head having a plurality of ink nozzles arranged in a direction perpendicular to a direction of feeding a print medium;

print head control means for driving the print head in the direction perpendicular to the direction of feeding the print medium;

position detection means for detecting a position of the print medium with respect to the print head; and

print control means for performing printing on a print area whose width is smaller than a maximum print width of the print head by using predetermined ink nozzles of the print head while moving the print medium relative to the print head, moving the print head in the direction perpendicular to the direction of feeding the print medium via the print head control means each time it has performed printing a predetermined number of times while moving the print medium based on the position detected by the position detection means, and again performing printing on the print area by using ink nozzles which are different at least partly from the predetermined ink nozzles.

To achieve the above objects, a computer program according to a fourth aspect of the present invention controls a computer to implement a printing method for performing printing by using a print head having a plurality of ink nozzles, comprising:

a printing step of performing printing on a print target area whose width is smaller than a maximum print width of a print head by using a predetermined ink nozzle head among a plurality of ink nozzles possessed by the print head while moving a print medium relative to the print head;

a moving step of detecting that printing has been performed a predetermined number of times, and moving the print head in a direction perpendicular to a direction of feeding the print medium; and

a resumed printing step of performing printing on the print target area on the print medium by using ink nozzles which are different at least partly from the predetermined ink nozzles of the print head after moved.

This computer program is distributed while stored in a recording medium, or transmitted while embedded on a carrier wave.

### EFFECTS OF THE INVENTION

According to the present invention, in a line inkjet printer, the ink nozzles of the print head can be used more equally, therefore ejection troubles of the ink nozzles can be reduced. Further, the life of the print head as a whole can be improved.

### BRIEF DESCRIPTION OF DRAWINGS

FIG. 1 It is a perspective diagram showing one embodiment of an inkjet printer of the present invention.

FIG. 2 It is a perspective diagram of a naked print head used for the inkjet printer of FIG. 1, as seen from a side of its nozzle surface.

FIG. 3 It is a block diagram showing the control system of the inkjet printer of FIG. 1.

FIGS. 4(A) to FIG. 4(C) are diagrams for explaining the positional relationship between a print target area and ink nozzles, and a manner to expand dot pattern data on a line buffer memory in accordance with the position of the ink nozzles. To be more specific, FIG. 4(A) is a diagram for explaining a case where the print head is at the home position. FIG. 4(B) is a diagram for explaining a state that the print head is moved from the home position by three dots in the rightward direction of the drawing. FIG. 4(C) is a diagram for explaining a state that the print head is moved from the home position by three dots in the rightward direction of the drawing.

FIGS. 5(A) to FIG. 5(C) are plan views showing the positional relationship among the position of the print head, the print target area, and a printed character string. To be more specific, FIG. 5(A) is a diagram for explaining a case where the print head is at the home position. FIG. 5(B) is a diagram for explaining a case where the print head is in a state of being moved from the home position in the rightward direction of the drawing. FIG. 5(C) is a diagram for explaining a case where the print head is in a state of being moved from the home position in the leftward direction of the drawing.

FIG. 6A It is a diagram showing an example of the moving pattern of the print head; a diagram showing an example of the moving pattern, according to which the character string is printed while the print head is moved by a predetermined amount each time also when the print head returns to the initial position after it reached one end of its movable range.

FIG. 6B It is a diagram showing an example of the moving pattern of the print head; a diagram showing an example of the moving pattern of a case where the amount of movement SA for each move is larger than shown in FIG. 6A.

FIG. 6C It is a diagram showing an example of the moving pattern of the print head; a diagram showing an example of the moving pattern of a case where the amount of movement SA for each move is smaller than shown in FIG. 6A.

FIG. 6D It is a diagram showing an example of the moving pattern of the print head; a diagram showing an example of the moving pattern, according to which, the print head is returned all at once to the initial position after it reached one end of its movable range.

FIG. 6E It is a diagram showing an example of the moving pattern of the print head, and showing a moving pattern, according to which the print head is placed at a same position while it prints the character string plural times, after it reached one end of its movable range.

FIG. 7 It is a flowchart for explaining an example of an operation of performing printing while moving the print head in a direction perpendicular to the conveying direction of the print medium.

FIG. 8 It is a flowchart for explaining an example of a process of shifting (moving) the print head.

### EXPLANATION OF REFERENCE NUMERALS

F packaging film
M register mark
SP specific print
10 inkjet printer
21 device frame
22 print section
23 maintenance section
24 guide rail
25 head carrier
26 print head
26a case
26b head body
26c nozzle surface
26d ink nozzles
27 platen
28 guide rollers
29 wiper section
30 sucking section
31 sensor
40 slave roller
101 supply roll
102 take-up roll
103 print medium feeding device
104 ball screw drive mechanism
105 encoder
107 head carrier drive circuit
108 print head control circuit
110 CPU (Central Processing Unit)
111 head carrier control circuit
112 print medium feeding control circuit

### BEST MODE FOR CARRYING OUT THE INVENTION

An inkjet printer 10 according to an embodiment of the present invention will be explained. The inkjet printer 10 is intended for printing an expiration date on a print medium comprising a packaging material, for each packaging unit.

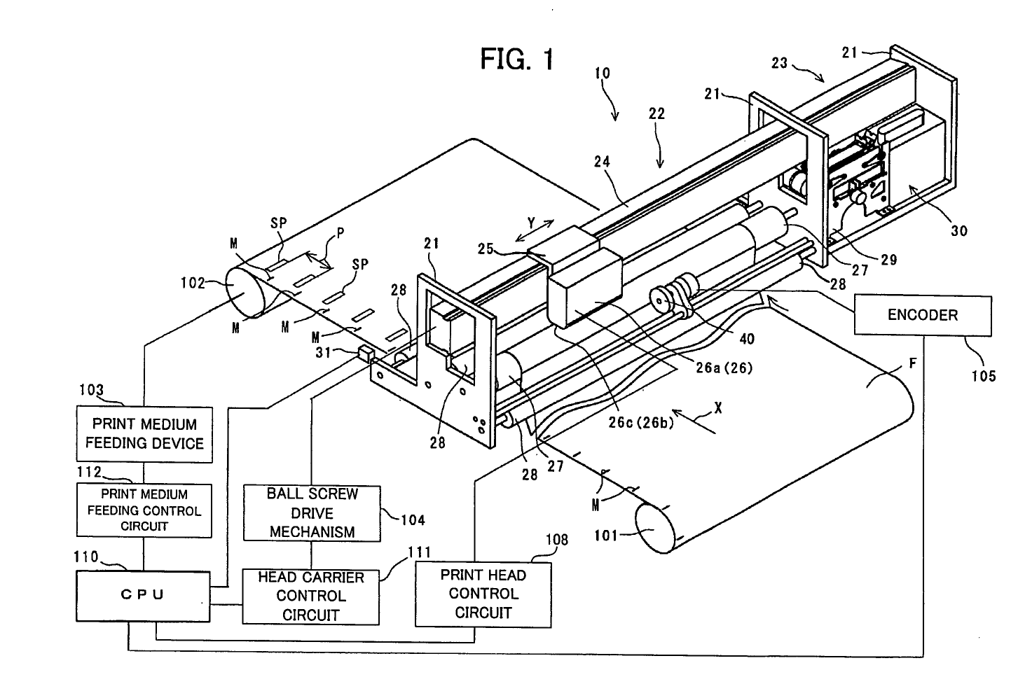

As shown in FIG. 1, a packaging instrument including the inkjet printer 10 prints, for example, an expiration date on a packaging film (print medium) F supplied from a supply roll 101 for each packaging unit, and packages the product with the packaging film. The inkjet printer 10 prints an expiration date on the packaging film F supplied from the supply roll 101.

A take-up roll 102 winds up the packaging film F on which the expiration date has been printed. A register mark M is printed in advance on one side of the packaging film F in the widthwise direction at regular intervals (at each packaging unit, for example, at each 300 mm interval). The take-up roll 102 is rotationally driven by a print medium feeding device 103. When the take-up roll 102 is driven in accordance with the driving by the rotation medium feeding device 103, the packaging film F is fed (conveyed).

A sensor 31 comprises, for example, an optical sensor or the like, and detects the register mark M along with the packaging film F being fed. The direction in which the packaging film F is driven (feeding direction) is assumed as X direction.

The device frame 21 of the inkjet printer 10 extends in a Y direction which is perpendicular to the X direction as seen in plan view perspective. The device frame 21 has a print section 22 and a maintenance section 23 on the right. A guide rail 24 extends in the Y direction over the print section 22 and the maintenance section 23, and fixed on the print section 22 and the maintenance section 23. The guide rail 24 supports a head carrier 25 so as to be able to move in the Y direction. The guide rail 24 internally has a feed screw (not shown) comprising a ball screw for moving the head carrier 25 in the Y direction. The head carrier 25 moves in the positive direction of the Y direction when the feed screw is positively rotated by a ball screw drive mechanism 104, while the head carrier 25 moves in the negative direction of the Y direction when the feed screw is negatively rotated.

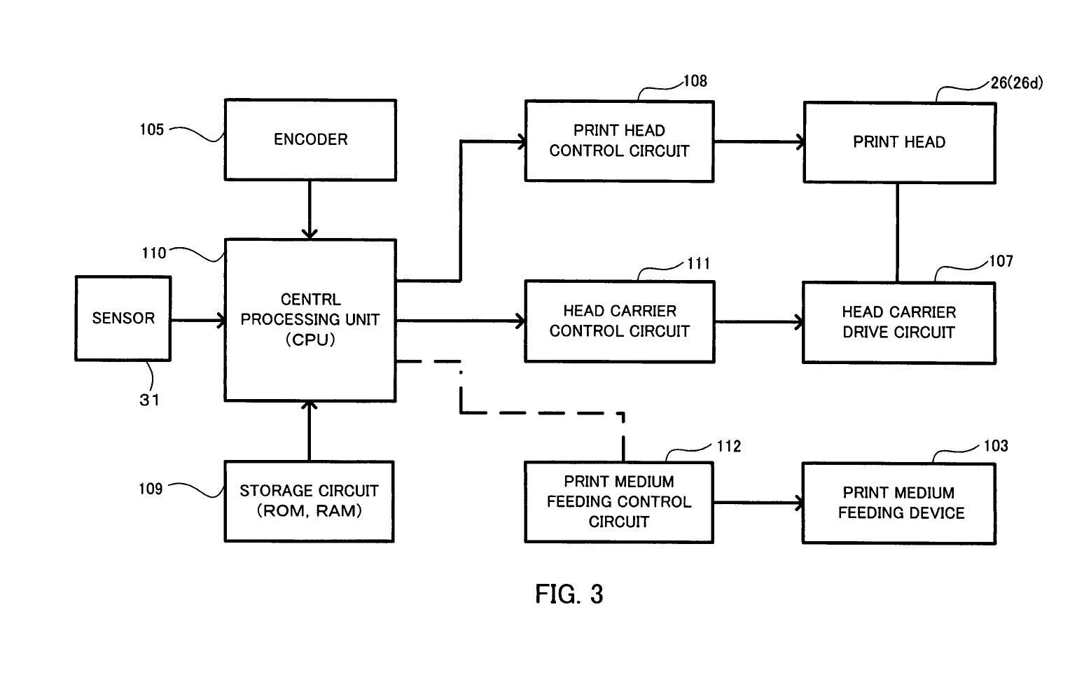

The ball screw drive mechanism 104 comprises a motor for positively rotating or negatively rotating the feed screw, for example, a pulse motor. The ball screw drive mechanism 104 is one example of a head carrier drive mechanism to be driven by a head carrier drive circuit 107 (FIG. 3). The position of the head carrier 25 in the Y direction is controlled by controlling the rotation angle of the pulse motor included in the ball screw drive mechanism 104. The rotation angle of the pulse motor may be controlled by open control, or the rotational position of the feed screw may be detected by an encoder so that the rotation angle may be controlled by closed control based on the detected rotational position.

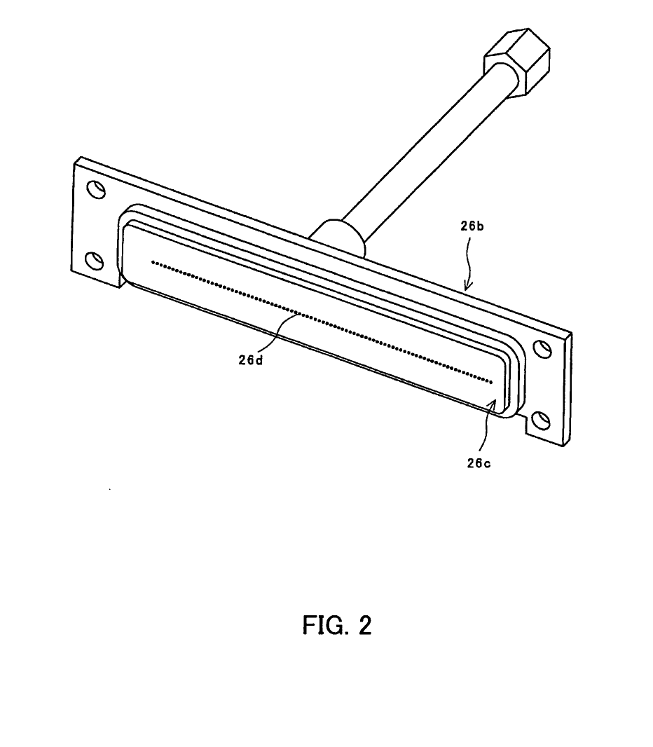

The head carrier 25 is detachably mounted with a print head 26. The print head 26 comprises an inkjet printer head. The inkjet printer head comprises a case 26a having a generally rectangular-parallelepiped shape, a head body 26b contained in the case 26a, and an ink tank (not shown). The head body 26b, as its independent shape being shown in FIG. 2, has a nozzle surface 26c that is elongate in the Y direction at its lower surface. Multiple ink nozzles 26d are formed in the nozzle surface 26c while arranged at an equal pitch in the longer-dimensional direction (Y direction). Though the ink nozzles 26d are arranged in one line in the Y direction in FIG. 2, they may be arranged in plural lines in the Y direction such as in a staggered arrangement, etc. in order for the dot density to be increased.

The head carrier 25 and the head carrier drive mechanism (to be driven by the head carrier drive circuit 107 (FIG. 3)) comprising the ball screw drive mechanism 104 can drive the head carrier 25 (print head 26) in the Y direction at a resolution equal to or greater than the arrangement pitch of the ink nozzles 26d.

A platen 27 is supported in the print section 22 of the device frame 21 in parallel with the guide rail 24. The platen 27 has a length corresponding to the entire range of movement of the print head 26 that moves along the guide rail 24, i.e., corresponding to the entire width of the packaging film F. The platen 27 sandwiches the print packaging film F between itself and the print head 26 regardless of the position of the print head 26 and holds the packaging film F flat, so that the print head 26 is enabled to perform printing on the packaging film F.

A plurality of guide rollers 28 are supported in the print section 22. The guide rollers 28 guide the packaging film F that runs out from the supply roll 101 to between the platen 27 and the print head 26, and discharge the print film F finished with printing toward the take-up roll 102.

An encoder 105 is fixed on the device frame 21. The encoder 105 has a slave roller 40, which sandwiches the packaging film F between itself and the platen 27 (or contacts the surface of the film). The slave roller 40 rotates in accordance with the packaging film F being fed (conveyed), and the amount of that rotation (i.e., the amount of movement of the packaging film F) is detected by the encoder 105. The amount of movement of the packaging film F can also be detected by detecting the amount of rotation of the take-up roll 102, etc. However, with the encoder 105 of an add-on type, it is possible to easily detect the amount of movement without modifying the existing instrument.

The maintenance section 23 has a wiper section 29 and an sucking section 30. The wiper section 29 wipes out any ink adhered to the nozzle surface 26c of the print head 26. The sucking section 30 puts the nozzle surface 26c in a vacuum atmosphere while the printing is stopped, and sucks and removes any foreign matters and extra ink from the nozzle surface 26c.

Next, the main part of the circuit structure of the packaging apparatus having the above-described mechanical structure will be explained.

As shown in FIG. 3, the line inkjet printer 10 comprises a print head control circuit 108, a storage circuit 109, and a central processing unit (CPU) 110, in addition to the encoder 105, head carrier drive circuit 107, and print medium feeding control circuit 112 described above.

The print head control circuit 108 internally comprises a print buffer (dot pattern memory) and a driver circuit for performing control of ink ejection from the ink nozzles of the print head 26. The print head control circuit 108 controls which nozzles of the multiple ink nozzles 26d of the print head 26 should be used to perform printing, based on dot pattern data expanded on the print buffer.

The storage circuit 109 comprises a semiconductor storage circuit such as a ROM, a RAM, etc., and print information is pre-stored therein and supplied to the CPU 110. The print information includes character information specifying the character string (text, symbol, numeral, etc. pictogram, etc.) to be printed and print position information specifying the position of the character string. The print position information is information that specifies at what position in the widthwise direction and lengthwise direction of the packaging film F the character string should be printed. In the present example, the print information is pre-stored in the storage circuit 109 by manual input or in other manners, but it is likewise possible that it be input in the RAM serving as the work area of the CPU 110 by manual input, reading out from a communication/recording medium, etc.

Note that the storage circuit 109 may store each character information to be printed in a dot pattern form, or may store them in a code information form. The CPU 110 generates information that defines the dot pattern (whether a dot is printed or not printed) of a dot line to be printed, based on the character information, and supplies it to the print head control circuit 108. For example, in a case where the character information is stored in the storage circuit 109 in the dot pattern form, the CPU 110 reads out the dot pattern to be printed from the storage circuit 109, and supplies it to the print head control circuit 108 in the unit of dot line. Or, for example, in a case where the character information is stored in the storage circuit 109 in the code information form, the CPU 110 reads out the code information to be printed and its attribute information (control information) from the storage circuit 109, and expands the dot pattern of the character string to be printed on the work memory by using a character generator or the like prepared in the storage circuit 109. The CPU 110 reads out the expanded dot pattern in the unit of dot line, and supplies it to the print head control circuit 108.

Further, the CPU 110 moves the head carrier 25 to a specific position in the widthwise direction of the packaging film F via the head carrier control circuit 111 and the ball screw drive mechanism 104, based on the print position information.

The line inkjet printer performs printing on a specific print position that is narrower than the maximum print width allowed by the print head 26 by using certain ink nozzles that are specified according to the print information while fixing the print head 26 but conveying the packaging film F with respect to the print head 26 by each predetermined pitch. The CPU 110 is supplied from the sensor 31 with a detection signal indicating that the register mark M on the packaging film F is detected. Further, the CPU 110 is supplied from the encoder 105 with a signal corresponding to the amount of the packaging film F fed. For example, a pulse signal is supplied each time the packaging film F is conveyed by a fixed amount.

The CPU 110 obtains the amount of the packaging film fed after the sensor 31 detects the register mark M, based on the detection signal from the sensor 31 and the signal from the encoder 105 indicating the amount of movement. The CPU 110 drives the take-up roll 102 intermittently or continually via the print medium feeding control circuit 112 and the print medium feeding device 103, based on the amount of movement obtained and the print position information (information on the relative position of the packaging film F with respect to the print head 26) read out from the storage circuit 109. Specifically, for example, the CPU 110 performs a printing operation one (prints the expiration date information once) when the packaging film F is fed by a predetermined amount after the sensor 31 detects one register mark M.

The sensor 31 and the encoder 105 constitute relative position detection means for detecting the feeding position (feeding amount) of the packaging film F with respect to the head carrier 25 (print head 26). Note that suggested by the CPU 110 and the print medium feeding control circuit 112 being connected by a broken line in FIG. 3, is that the present inkjet printer 10 is applicable to an existing packaging instrument.

Further, in order to prevent an occurrence of a situation, which accompanies when the same content is repeatedly printed, that only specific ink nozzles 26d of the print head 26 continue to be used and certain ink nozzles 26d are barely used, the CPU 110 moves the head carrier 25 in the Y direction periodically. To be more specific, further, in order to prevent an occurrence of a situation, which accompanies when the same content is repeatedly printed, that only specific ink nozzles 26d of the print head 26 continue to be used and certain ink nozzles 26d are hardly used, the CPU 110 moves the head carrier 25 in the Y direction periodically.

To be more specific, when the same content is to be repeatedly printed, the CPU 110 counts the number of print times. Then, the CPU 110 instructs the head carrier control circuit 111 to move the head carrier 25 in the Y direction by a predetermined shift amount SA each time the printing operations have been performed a predetermined number of times (for example, 1 to 5 times), and fixes the head carrier 25 (print head 26) at the position reached by the movement. Further, the CPU 110 instructs the print head control circuit 108 to select, as the ink nozzles 26d to be used for printing, those that exist in a range shifted by the shift amount SA in the reverse direction to the direction in which the head carrier 25 has been shifted, and that face a print target area Ar.

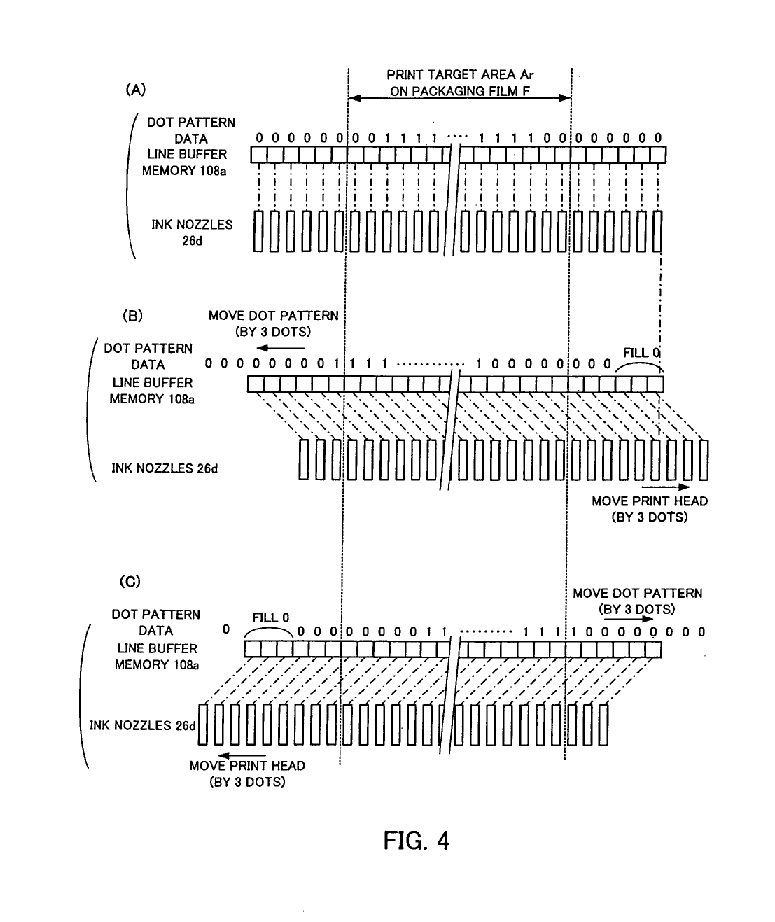

A more detailed explanation will be given with reference to FIG. 4(A) to FIG. 4(C).

The print head control circuit 108 comprises a line buffer memory (dot pattern memory) 108a for storing a dot pattern to be printed. The line buffer memory 108a may be such a one that has a capacity suitable for storing dot pattern data amounting to one dot line or several dot lines of the print object, or may have a size that allows the full print object data to be expanded.

Each storage cell of the line buffer memory 108a corresponds to any one of the ink nozzles 26d of the print head 26. When any data representing printing is stored in the respective storage cells, the driver circuit for the print head 26 ejects ink from the corresponding nozzles 26d to form dots of ink on the print medium F.

As an example, assume a case that the print head 26 is positioned to face the print target area Ar on the packaging film F as shown in FIG. 4(A) and a dot line corresponding to a dot pattern “001111 . . . 1100” is to be printed in this state. Here, “0” indicates a dot at which ink should not be ejected, and “1” indicates a dot at which ink should be ejected. Among the storage cells (bit memories) in the line buffer memory 108a (buffer memory for storing dot data of the print object line) included in the print head control circuit 108, those storage cells that correspond to the ink nozzles 26d within the print target area Ar store bit data “1” or “0” indicating whether the corresponding ink nozzles 26d are to eject ink or not. And the registers corresponding to the ink nozzles 26d that are positioned outside the print target area Ar have “0”, which indicates that ink is not to be ejected, expanded therein.

When printing has been performed in this state a predetermined number of times, for example, 10 times, the CPU 110 moves the print head 26 by the amount of movement SA as shown in FIG. 4(B) or FIG. 4(C), via the head carrier control circuit 111. FIG. 4(B) shows a state that the print head 26 is moved in the rightward direction in the drawing by 3 dots (by 3 ink nozzles) with respect to FIG. 4(A). FIG. 4(C) shows a state that the print head 26 is moved in the leftward direction in the drawing by 3 dots (by 3 ink nozzles) with respect to FIG. 4(A).

Further, the CPU 110 shifts the dot pattern data expanded on the line buffer memory 108a in the reverse direction to the direction corresponding to the direction in which the print head 26 has been moved by some dots corresponding to the amount of movement of the print head 26, so that printing can be made on relatively the same position within the print target area Ar even after the print head 26 is moved. Then, “0” is added where there is no corresponding data that should be stored.

This printing operation will be more specifically explained below.

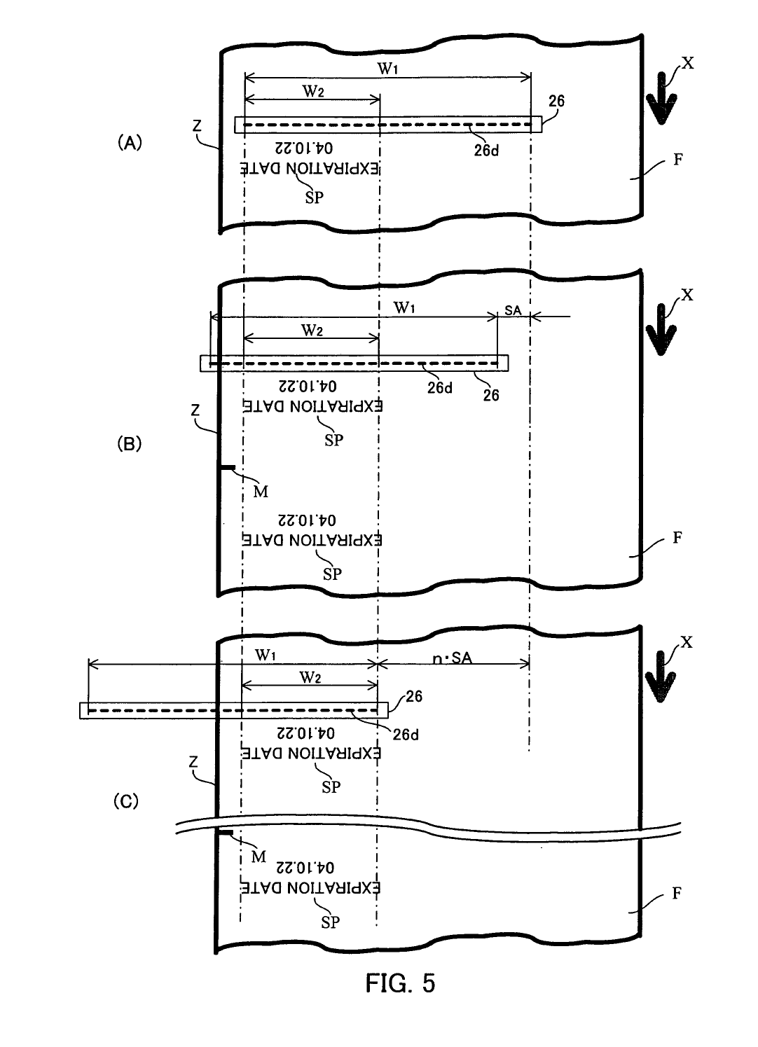

FIGS. 5(A) to 5(C) illustrate the mode of this printing. In FIGS. 5(A) to 5(C), the symbol W1 indicates the maximum print width allowed by the print head 26, and the symbol W2 indicates the print target area Ar narrower than W1. A character string SP “expiration date 04. 10. 22” is to be printed on the print target area Ar on the packaging film F. The character string SP is applied at a same position in the widthwise direction of the packaging film F. The symbol Z in FIG. 5(A) to 5(C) indicates one end of the packaging film F in the widthwise direction, which end does not shift.

FIG. 5(A) shows the mode of initial printing by the print head 26 (head carrier 25). The printer 10 performs printing a predetermined number of times while the packaging film F and the print head 26 are at this relative position. Then, as shown in FIG. 5(B), the CPU 110 moves the print head 26 in the Y direction by the shift amount SA, fixes it there again, and prints the same character string SP at the same position by using a set of ink nozzles 26d that exist in a range which is shifted by the shift amount SA from the set of ink nozzles 26d that were used in the state shown in FIG. 5(A). Thereafter, when printing has been done the predetermined number of times at the position shown in FIG. 5(B), the CPU 10 repeats the same operation, and at every such repetition, moves the print head 26 in the Y direction by the shift amount SA, fixes it there, and executes the same character string SP by using a set of ink nozzles 26d existing in a range shifted further by the shift amount SA. FIG. 5(C) shows a state of the print head 26 being repetitively moved n times including the first move.

The above-described printing operation comprises the following three steps.

1. The first step of fixing the position of the print head 26 in the Y direction, and while moving the packaging film F with respect to the print head 26 in the feeding direction by each predetermined pitch, printing the character string on the print target area narrower than the maximum print width of the print head 26 by using the ink nozzles 26d existing in the range of the print target area Ar.

2. The second step of moving the print head 26 in the Y direction by the predetermined shift amount SA and fixing it again, each time printing has been performed a predetermined number of times (including once).

3. The third step of performing the same printing on the specific print position by using the ink nozzles 26d that are positioned in a range facing the print target area Ar, while the print head 26 is at the position reached by the movement.

The ink nozzles 26d used at the third step are different at least partly from the ink nozzles 26d used at the preceding first step or the closest preceding third step.

The shift amount SA is not limited to only the predetermined shift amount, but also can be a random shift amount generated from a random number table or the like.

After the print head 26 reaches one end of movement, it is preferred that any of the modes be taken that, for example,

1. the print head 26 is returned to the initial position all at once, and the same printing operation is performed, and

2. also for the returning operation, the operation of moving the print head 26 by the predetermined shift amount SA is repeated each time the printing has been performed a predetermined number of times, thereby returning the print head to the initial position.

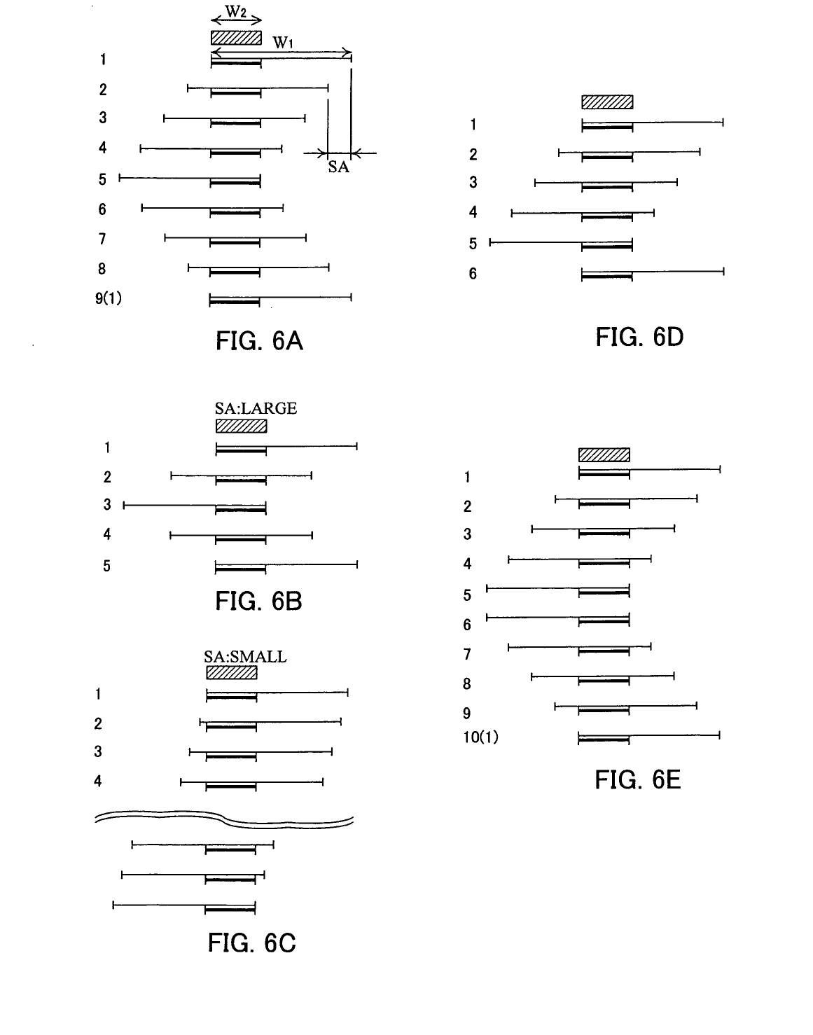

FIG. 6A to FIG. 6E show examples of patterns of movement of the print head 26.

FIG. 6A, FIG. 6B, and FIG. 6E show examples that the character string SP is printed while the print head 26 is moved by each predetermined amount also after the print head 26 reaches one end of movement. FIG. 6D shows an example that the print head 26 is returned to the initial position all at once after the print head reaches one end of movement. According to the example of FIG. 6E, when the print head 26 reaches one end of the movable range of the print head 26, the print head 26 is kept at the same position while the character string is printed a predetermined number of times (twice).

As shown in FIG. 6A, FIG. 6B, and FIG. 6E, it is possible to perform printing with a step of the print head 26 reciprocating between one end and the other end of its movable range, if the character string SP is printed while the print head is moved by each predetermined amount SA also when the print head 26 is to be returned to the initial position after the print head 26 reaches one end of the movable range. Therefore, it is possible to effectively use the step of reciprocation of the print head 26 in performing a specific print job, thereby to improve the printing efficiency in terms of the movement of the print head 26.

FIG. 6C shows an example where the shift amount SA is very small (for example, the print head 26 is moved each time the character string SP is printed once). The shift amount SA can be set arbitrarily. For example, in consideration of the printing pitch p (FIG. 1) of the character string SP, such a setting manner may be taken as to make the shift amount SA of the print head 26 large in a case where the pitch p is long because so much long a time is spent to feed the packaging film F in such a case.

When the shift amount SA is set large, it is possible to move many ink nozzles along the moving direction of the print head 26, per movement of the print head 26. This makes it possible to use more ink nozzles along with one movement of the print head 26, and to use the multiple ink nozzles more equally.

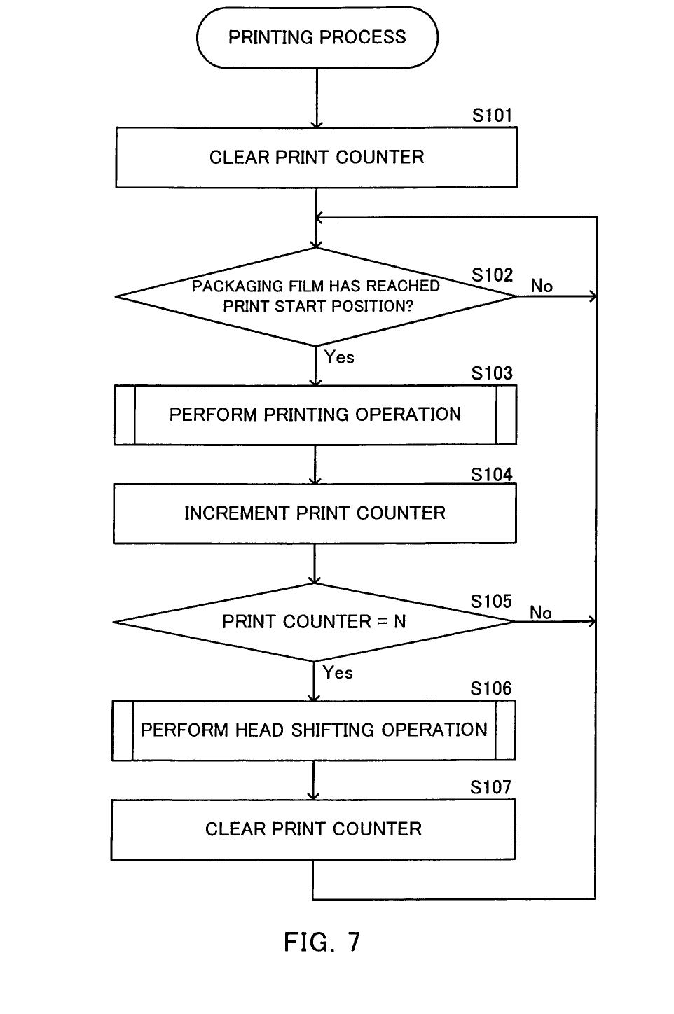

FIG. 7 is an example of a flowchart for performing the printing process.

The CPU 110 discloses the process of FIG. 7, in a case where it starts the process of printing the same character string repeatedly. First, the CPU 110 clears a print counter for counting the number of print times (step S101). Next, the CPU 110 activates the print medium feeding device 103 via the print medium feeding control circuit 112 in another routine to start feeding the packaging film F. Next, the CPU 110 determines whether or not the packaging film F has reached a predetermined print position in the X direction (step S102). When it is determined that the packaging film F has reached the print position (step S102; Yes), the CPU 110 prints the character string SP on the print target area Ar (step S103), and increments (adds 1 to) the print counter each time the printing is performed once (step S104). The CPU 110 repeats the above printing operation until the number of print times reaches a predetermined number N (step S105, S102 to S104).

On the one hand, in a case where it is determined that the number of times of the specific printing has reached the predetermined number N (step S105; Yes), the CPU 110 controls the head carrier control circuit 111 to drive the ball screw drive mechanism 104, so that the position of the print head 26 may be shifted in the Y direction by the shift amount SA (step S106). Then, the CPU 110 clears the print counter (step S107), returns the process to step S102 and repeats the above-described operation.

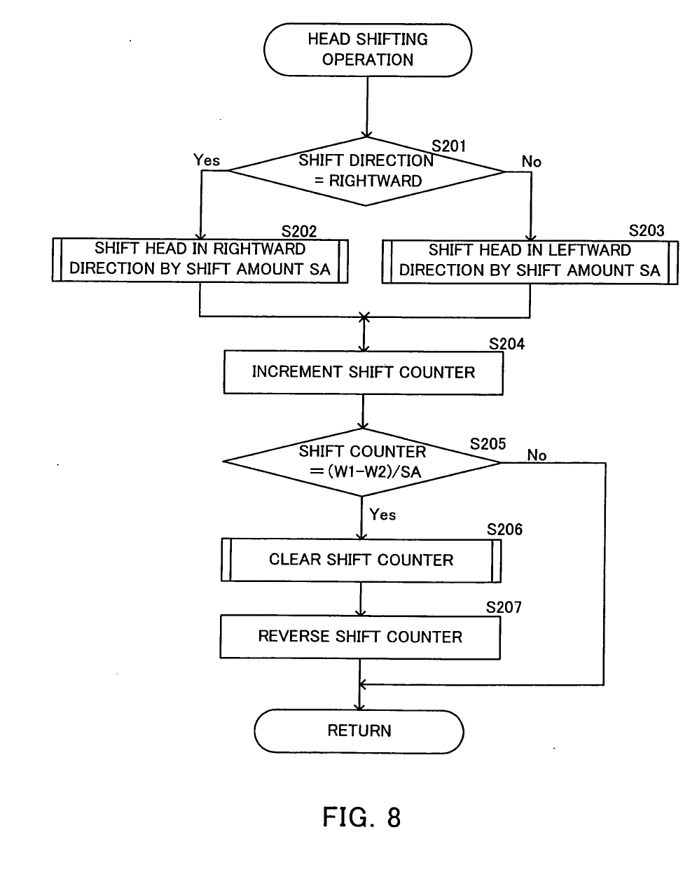

FIG. 8 is a flowchart for explaining the head shifting operation at step S106 of FIG. 7, i.e., the process of moving the print head 26 by the specific shift amount SA and reversing the shift direction when the print head 26 reaches an end of movement.

When this process is started, the CPU 110 determines whether the shift direction is set to the rightward direction or set to the leftward direction from, for example, the content of a shift direction flag set in the internal memory (step S201), and moves the print head 26 by the shift amount SA in the shift direction set (step S202 or S203). Note that in a case where the print head 26 cannot be moved by the shift amount SA, it may be moved by the maximum range of movement possible. Then, the CPU 110 increments (adds 1 to) a shift counter that counts the number of times of shifting made in the same direction (step S204). Then, the CPU 110 determines whether or not the count value has reached (W1-W2)/SA (that is, whether or not the print head 26 has reached the end of movement) (step S205), terminates the instant process in a case where the print head has not reached the end of movement (step S205; No), and returns to the printing process of FIG. 7 to go to step S107.

On the other hand, in a case where it is determined at step S205 that the print head 26 has reached the end of movement (step S205; Yes), the CPU clears the shift counter (step S206), inverses the value of the shift direction flag to reverse the shift direction (step S207), and terminates the instant process to return to the printing process of FIG. 7 and go to step S107.

As explained above, according to the present embodiment, even in a case where data is to be printed on a print area narrower than the width of one dot line of the print head 26, all the ink nozzles 26d can be used for printing.

The present invention is not limited to the above-described embodiment, but can be modified or applied in various manners.

For example, in the above-described embodiment, the present invention has been explained by employing, as an example, a case where the same data representing an expiration date is repeatedly printed on a plurality of print areas arranged at a predetermined pitch on a sheet-like packaging film F. However, the print medium, the objective data, and the printing mode are arbitrary. For example, the present invention can be applied to an inkjet printer for printing on a plurality of sheets. Further, the print data may be the same or may be changed.

Further, the situation in which the printer is used, and the structure and operation of the control unit of the printer are not limited to the above-described example. For example, the circuit structure shown in FIG. 3 and the flowcharts shown in FIG. 7 and FIG. 8 are mere examples, and can thus be modified arbitrarily. For example, the print head control circuit 108 and head carrier control circuit 111 shown in FIG. 3 may be constituted by a processor of a controller function. Further, though it is preferred that the X direction and the Y direction shown in FIG. 1 be at right angles, these may not be at right angles.

For example, the present invention can also be applied to a case where arbitrary data are sequentially printed on one print area narrower than the maximum print width of the print head 26. Also in this case, those ink nozzles at the edges, that would not be used for printing if they were in a conventional inkjet printer, can be used for printing.

Further, according to the above explanation, the print head 26 is moved each time the character string representing the expiration date has been printed a predetermined number of times. However, the timing to move the print head 26 is arbitrary. For example, the print head 26 may be moved each time printing of significant data has been performed a pre-designated number of times (a fixed value or a value determined according to a certain rule) or a number of times calculated randomly. Further, the print head 26 may be moved each time printing has been performed for an arbitrary number of dot lines.

Furthermore, the print area may be predefined on the print medium or may be defined by the inkjet printer.

The present invention can be implemented in a case where the width of the print area preset on the print medium is narrower than the maximum print width of the print head 26. For example, it may be detected when the width of the data to be actually printed (the width within which ink is ejected) is narrower than the maximum print width of the print head 26, and then the above-described process of moving the print head 26 may be performed. In this case, for example, the CPU 110 specifies the width of the area on which ink is to be printed from dot pattern data expanded on the line buffer memory (on which dot pattern data amounting to one dot line or a plurality of dot lines is expanded) or on a page buffer (on which dot pattern data amounting to one page is expanded), determines whether the width of the ink printing area is narrower than the maximum print width or not, and performs the above-described operation of moving the print head regularly or irregularly, in a case where it is determined that the width is narrower.

The value of the amount of movement SA of the print head 26 is arbitrary. However, it is preferred that the value be a multiple of the ink nozzle arranging pitch as multiplied by any natural number. Further, it is preferred that the value be (total number of ink nozzles−number of ink nozzles corresponding to the print area)×ink nozzle pitch.

Further, an example has been shown, with reference to FIG. 4(A) to FIG. 4(C), in which the position of the dot pattern data expanded on the line buffer memory 108a is shifted in accordance with the position of the print head 26. However, if it is not necessary to keep the print position unchanged, the operation of shifting the dot pattern data stored in the line buffer memory 108a may not be performed.

Further, the present invention can be applied to a serial inkjet printer. That is, in a case where data is printed on a print area which is narrower than the length (the width of the row of one printing) of the column of ink nozzles of the serial inkjet printer, the print head may be moved regularly or irregularly in the same direction as the column of ink nozzles.

The present invention can also be applied to a color printer. In this case, the above-described control may be performed for the print head of the respective colors (for example, Y (yellow), M (magenta), C (cyan), and black).

All or part of a computer program for controlling the CPU 110, etc. to perform the above-described printing operation and control operation may be stored in a recording medium (a ROM, a flexible disk, a hard disk, a CD-ROM, an MO, a CD-R, a flash memory, etc.) so as to be distributed or circulated, or may be installed in a memory of a controller function. Further, a carrier wave may be modulated by a data signal representing such a program and transmitted via a communication network so that the program may be distributed or circulated.

This application is based on Japanese Patent Application No. 2004-004449 filed on Jan. 9, 2004. The specification, claims, and drawings of Japanese Patent Application No. 2004-004449 is incorporated herein by reference in its entirety.

### INDUSTRIAL APPLICABILITY

The present invention can be used in the field of an inkjet printer and a printing method utilizing an inkjet printer.

1. An inkjet printer, comprising:
a print head having a plurality of ink nozzles arranged in a direction perpendicular to a direction of feeding a print medium;
a print head control circuit which drives said print head in the direction perpendicular to the direction of feeding the print medium;
a position detection circuit which detects a position of the print medium with respect to said print head; and
a print control circuit which performs printing on a print area whose width is smaller than a maximum print width of said print head by using predetermined ink nozzles of said print head while moving the print medium relative to said print head, moves said print head in the direction perpendicular to the direction of feeding the print medium via said print head control circuit each time it has performed printing a predetermined number of times while moving the print medium based on the position detected by said position detection circuit, and again performs printing on said print area by using ink nozzles which are different at least partly from said predetermined ink nozzles.

2. The inkjet printer according to claim 1,
wherein said print control circuit performs printing in a state that a position of said print head in the direction perpendicular to the direction of feeding the print medium is fixed, moves said print head via said print head control circuit in the direction perpendicular to the direction of feeding the print medium each time it has performed printing the predetermined number of times, and again performs printing in a state that said print head is fixed.

3. The inkjet printer according to claim 1,
wherein: said print control circuit performs a control of moving said print head via said print head control circuit from an initial position at which printing on said print area is performed for a first time to one end of movement along the direction perpendicular to the direction of feeding the print medium while repeatedly performing printing on said print area; and
performs a control of moving said print head via said print head control circuit from said one end of movement to said initial position along the direction perpendicular to the direction of feeding the print medium while repeatedly performing the same printing on said print area.

4. The inkjet printer according to claim 1,
wherein: said print head control circuit comprises a buffer memory on which a dot pattern, which is objective data to be printed, is expanded; and
said print head control circuit shifts a position at which the print-object dot pattern data is expanded in accordance with movements of said print head.

5. The inkjet printer according to claim 1,
wherein said position detection circuit comprises:
a sensor which detects a mark that is given on the print medium at predetermined intervals in the feeding direction; and
an encoder which detects an amount of the print medium being fed.

6. The inkjet printer according to claim 5,
wherein said encoder comprises a slave roller which rotates while keeping in contact with a surface of the print medium, and detects an angle of rotation of said slave roller.

7. A printing method by an inkjet printer, for performing printing by using a print head having a plurality of ink nozzles, comprising:
a printing step of performing printing on a print target area whose width is smaller than a maximum print width of a print head by using a predetermined ink nozzle head while moving a print medium relative to said print head; and
a moving step of detecting that printing has been performed a predetermined number of times, and moving said print head in a direction perpendicular to a direction of feeding the print medium,
wherein after said print head is moved, printing is performed at said printing step on the print target area on the print medium, by using ink nozzles which are different at least partly from ink nozzles which were used for printing before the move.

8. The printing method according to claim 7,
wherein: said printing step comprises a step of performing printing on a specific print position whose width is smaller than the maximum print width of said print head by using predetermined ink nozzles while further moving the print medium relative to a head carrier by a predetermined pitch at a time, in a state that a position of said print head in the direction perpendicular to the direction of feeding the print medium is fixed; and
said moving step comprises a step of moving said head carrier via said head carrier control circuit in the direction perpendicular to the direction of feeding the print medium.

9. The printing method according to claim 7,
wherein at said moving step, said print head is moved each time it is detected that printing has been performed the predetermined number of times; and
each time said print head is moved at said moving step, printing is performed at said printing step by using ink nozzles which are different at least partly from ink nozzles which were used for printing before the move.

10. The printing method by an inkjet printer according to claim 7,
wherein detection of a relative position of the print medium comprises a step of detecting a mark given on the print medium at predetermined intervals in the feeding direction, and a step of detecting an amount of the print medium being fed.

11. An inkjet printer, comprising:
a print head having a plurality of ink nozzles arranged in a direction perpendicular to a direction of feeding a print medium;
print head control means for driving said print head in the direction perpendicular to the direction of feeding the print medium;
position detection means for detecting a position of the print medium with respect to said print head; and
print control means for performing printing on a print area whose width is smaller than a maximum print width of said print head by using predetermined ink nozzles of said print head while moving the print medium relative to said print head, moving said print head in the direction perpendicular to the direction of feeding the print medium via said print head control means each time it has performed printing a predetermined number of times while moving the print medium based on the position detected by said position detection means, and again performing printing on said print area by using ink nozzles which are different at least partly from said predetermined ink nozzles.

12. A computer program for controlling a computer to implement a printing method for performing printing by using a print head having a plurality of ink nozzles, comprising:
a printing step of performing printing on a print target area whose width is smaller than a maximum print width of a print head by using a predetermined ink nozzle head among a plurality of ink nozzles possessed by said print head while moving a print medium relative to said print head;
a moving step of detecting that printing has been performed a predetermined number of times, and moving said print head in a direction perpendicular to a direction of feeding the print medium; and
a resumed printing step of performing printing on the print target area on the print medium by using ink nozzles which are different at least partly from said predetermined ink nozzles of said print head after moved.
